(19) United States
(12) Patent Application Publication
(10) Pub. No.: US 2009/0239165 A1
(43) Pub. Date: Sep. 24, 2009

(54) IMAGE FORMING APPARATUS USING AMORPHOUS SILICON PHOTOCONDUCTOR

(75) Inventors: Chikara Ishihara, Osaka-shi (JP); Ai Takagami, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/401,712

(22) Filed: Mar. 11, 2009

(30) Foreign Application Priority Data
Mar. 19, 2008 (JP) 2008-071088

(51) Int. Cl. G03G 15/00

(52) U.S. Cl. 430/56; 399/159

(57) ABSTRACT

An image forming apparatus is provided with an image forming unit including an amorphous silicon photoconductor. The amorphous silicon photoconductor includes a base and a photosensitive layer provided on the base. The photosensitive layer includes a highly resistive layer, a charge-injection inhibition layer, a photoconductive layer and a surface protecting layer successively laminated on the base. The thickness of the highly resistive layer is in the range of 1 μm to 4 μm. The thickness of the photosensitive layer is in the range of 15 μm to 25 μm and the absolute value of a solid light potential of the photosensitive layer is in the range of 20 to 100 V.

### BACKGROUND OF THE INVENTION

1. Field of the Invention

The present invention relates to a copier, a printer or a like electrophotographic image forming apparatus using an amorphous silicon photoconductor.

2. Description of the Related Art

Conventionally, amorphous silicon photoconductors have been widely used as electrophotographic photoconductors installed in electrophotographic image forming apparatuses such as copiers and printers, or the like. The amorphous silicon photoconductors have advantages of being good in mechanical strength, having little abrasion of photosensitive layers even in the case of repeated use and being able to stably supply images of good quality.

On the other hand, in order to meet the needs of a finer resolution, it has been promoted to thin photosensitive layers in amorphous silicon photoconductors. By thinning the photosensitive layer, capacitance in the photosensitive layer can be increased to improve a latent image electric field of an electrostatic latent image formed on a surface of the photosensitive layer, wherefore the resolution can be improved as desired.

However, in the case of thinning the photosensitive layer, the voltage resistance of the photosensitive layer was accordingly reduced and a problem of easy dielectric breakdown was found.

Accordingly, Japanese Unexamined Patent Publication No. S59-200244 (D1) discloses an amorphous silicon photoconductor in which a charge-injection inhibition layer having a specified layered structure is formed on a base and a photoconductive layer is formed on the charge injection inhibition layer in order to increase a withstand-voltage of a photosensitive layer. The amorphous silicon photoconductor of D1 includes the charge-injection inhibition layer in which a p-layer using electron holes as carriers and an n-layer using electrons as carriers are laminated.

Although it is not aimed to improve the voltage resistance of a photosensitive layer, but mainly aimed to improve the adhesive characteristic of a base and a photoconductive layer and the like, Japanese Unexamined Patent Publications No. S58-145961 (D2) or S58-145962 (D3) discloses amorphous silicon photoconductors in which an auxiliary layer made of amorphous silicon containing a specified ratio of nitrogen atoms is formed on a base and a photoconductive layer and the like are formed on this auxiliary layer. In the amorphous silicon photoconductors of D2 and D3, the auxiliary layer made of amorphous material containing up to 43 atomic % of nitrogen atoms as constituent atoms in silicon atoms as a matrix, the photoconductive layer and the like are laminated on the base.

However, while the amorphous silicon photoconductor of D1 can improve the voltage resistance to a certain extent, there were cases where charge transport efficiency in the photosensitive layer was excessively reduced and it was difficult to obtain a sufficient sensitivity.

Further, the amorphous silicon photoconductors of D2 and D3 keep silence the problem of the reduced voltage resistance which is the results by thinning the photosensitive layer. Thus, if the photosensitive layer was thinned, there were cases where the voltage resistance was easily reduced to cause a dielectric breakdown depending on the nitrogen content in the auxiliary layer, or the thickness of the auxiliary layer or conversely it became difficult to obtain a sufficient sensitivity.

Thus, even in the case of thinning the photosensitive layer to improve the resolution, there has been a demand for an amorphous silicon photoconductor capable of stably maintaining the sensitivity while having a specified voltage resistance.

### SUMMARY OF THE INVENTION

As a result of keenly studying the above mentioned problems, inventors of the present invention found out that sensitivity could be stably maintained while a specified withstand-voltage could be obtained even in the case of thinning a photosensitive layer with a specific structure by forming a highly resistive layer having a specified thickness and the like on a base and setting the absolute value of a solid light potential of the photosensitive layer in a specified range, and completed the present invention.

Accordingly, an object of the present invention is to provide an image forming apparatus using an amorphous silicon photoconductor capable of stably forming an image with a fine resolution upon suppressing an occurrence of a dielectric breakdown while thinning a photosensitive layer with a specific structure.

In order to accomplish this object, one aspect of the present invention is directed to an image forming apparatus which provided with an image forming unit including an amorphous silicon photoconductor having a base and a photosensitive layer formed on the base. The photosensitive layer includes a highly resistive layer, a charge-injection inhibition layer, a photoconductive layer, and a surface protecting layer laminated on the base successively aforementioned sequence. The thickness of the highly resistive layer is in the range of 1 μm to 4 μm; the thickness of the photosensitive layer is in the range of 15 μm to 25 μm; and the absolute value of a solid light potential of the photosensitive layer is in the range of 20V to 100V.

These and other objects, features, aspects and advantages of the present invention will become more apparent upon a reading of the following detailed description and accompanying drawings.

### BRIEF DESCRIPTION OF THE DRAWINGS

FIG. 1 is a graph showing a relationship between a voltage resistance and sensitivity of an amorphous silicon photoconductor used in the invention,

FIG. 2 is a schematic section showing the construction of an image forming apparatus according to the invention,

FIG. 3 is a diagram showing the structure of the amorphous silicon photoconductor,

FIG. 4 is a graph showing a relationship between the thickness of a highly resistive layer and the absolute value of a negative withstand-voltage of the highly resistive layer,

FIG. 5 is a graph showing a relationship between the thickness of the highly resistive layer and the absolute value of a solid light potential,

FIG. 6 is a graph showing a relationship between the thickness of a photosensitive layer and resolution, and

FIGS. 7A to 7E are diagrams showing print dot patterns.

### DETAILED DESCRIPTION OF THE PREFERRED EMBODIMENTS

### First Embodiment

As a first embodiment, there is shown an image forming apparatus having amorphous silicon photoconductors each of which provided with a photosensitive layer on a base. The photosensitive layer consists of a highly resistive layer, a charge-injection inhibition layer, a photoconductive layer, and a surface protecting layer, which are successively laminating on the base in the aforementioned sequence. Each amorphous silicon photoconductors is installed in an image forming unit. In this amorphous silicon photoconductor, the thickness of the highly resistive layer is in the range of 1 μm to 4 μm, that of the photosensitive layer is in the range of 15 μm to 25 μm and the absolute value of a solid light potential of the photosensitive layer is in the range of 20V to 100V.

Hereinafter, the image forming apparatus according to the first embodiment is specifically described for the respective constituent elements.

### 1. Basic Construction

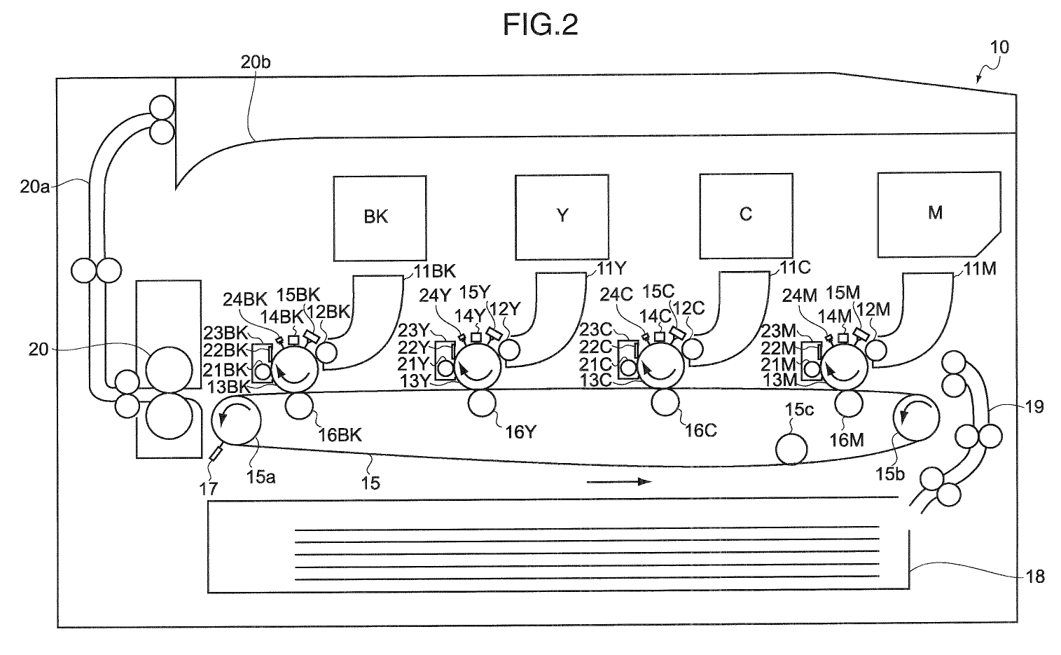

The image forming apparatus of this embodiment is provided with amorphous silicon electrophotographic photoconductors, charging devices, exposing devices, developing devices, transferring devices, a fixing device and neutralizing devices. A basic construction of the image forming apparatus of this embodiment is described below, taking a full-color image forming apparatus 10 shown in FIG. 2 as a specific example.

The full-color image forming apparatus 10 includes an endless belt (conveyor belt) 15. The endless belt 15 conveys a recording sheet fed from a sheet cassette 18 toward a fixing device 20. A magenta developing device 11M, a cyan developing device 11C, a yellow developing device 11Y and a black developing device 11BK are arranged along a conveying direction of the recording sheet above the endless belt 15.

Amorphous silicon photoconductors 13M, 13C, 13Y and 13BK are arranged to face developing rollers 12M, 12C, 12Y and 12BK. Charging devices 14M, 14C, 14Y and 14BK for charging the surfaces of the amorphous silicon photoconductors 13M to 13BK and exposure devices 15M, 15C, 15Y and 15BK for forming electrostatic latent images on surfaces of the amorphous silicon photoconductors 13M to 13BK are arranged around these amorphous silicon photoconductors 13M to 13BK. The electrostatic latent images formed on the amorphous silicon photoconductors 13M to 13BK corresponding to the respective colors are developed by the developing devices 11M to 11BK corresponding to the respective colors.

The full-color image forming apparatus 10 further includes transferring devices, cleaning devices 23M, 23C, 23Y, and 23BK and neutralizing devices 24M, 24C, 24Y, and 24BK.

The transferring devices successively transfer developer images of the respective colors to the recording sheet conveyed by the endless belt 15 and are arranged at a side opposite to the amorphous silicon photoconductors 13M to 13BK via the endless belt 15.

The cleaning devices 23M to 23BK are arranged around the amorphous silicon photoconductors 13M to 13BK and include cleaning blades 22M, 22C, 22Y, and 22BK and rotary members 21M, 21C, 22Y, and 22BK. The cleaning blades 22M to 22BK remove untransferred developers remaining on the amorphous silicon photoconductors 13M to 13BK after the transfer of the developers of the respective colors. The rotary members 21M to 21BK carry abrasive particles such as titanium oxide particles contained in the developers to polish the surfaces of the amorphous silicon photoconductors.

The neutralizing devices 24M to 24BK are arranged downstream of the cleaning devices 23M to 23BK and neutralize remaining electric charges produced in photosensitive layers of the amorphous silicon photoconductors 13M to 13BK.

### 2. Amorphous Silicon Photoconductor

### (1) Basic Structure

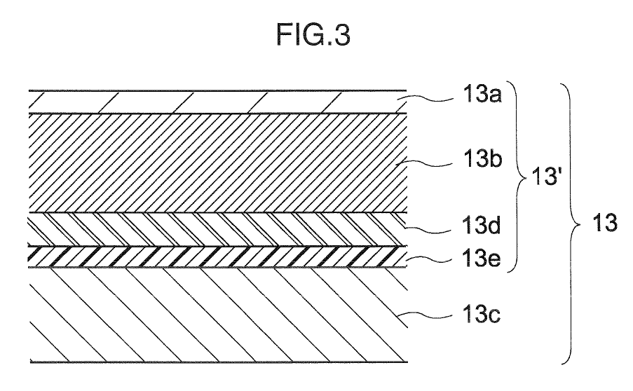

A basic structure of each amorphous silicon photoconductor 13 (13M, 13C, 13Y, and 13BK) in this embodiment is such that a photosensitive layer 13′ formed by successively laminating a highly resistive layer 13e, a charge-injection inhibition layer 13d, a photoconductive layer 13b and a surface protecting layer 13a is formed on a base 13c as shown in FIG. 3.

The reason for this is that an image with a pretty fine resolution can stably be formed by having such a basic layer structure of the amorphous silicon photoconductor 13 and respectively setting the thickness of the highly resistive layer 13e, the thickness and the absolute value of a solid light potential of the photosensitive layer 13′ in specified ranges. The respective constituent elements of the amorphous silicon photoconductor 13 are specifically described below.

### (2) Base

Conductive materials including metallic materials such as aluminum, stainless steel, zinc, copper, iron, titanium, nickel, chromium, tantalum, tin, gold, and silver, and alloy materials of these metals can be suitably used for the base 13c in the case where the amorphous silicon photoconductor 13 is a photoconductive drum. It is also possible to use a base obtained by forming a conductive film of one of the above metals and transparent conductive materials such as ITO and SnO₂ on a surface of an insulator made of resin, glass or ceramic by vapor deposition or the like.

### (3) Highly Resistive Layer

The highly resistive layer 13e is a layer formed mainly for the purpose of improving the voltage resistance of the photosensitive layer 13′ while suppressing the thickness of the photosensitive layer 13′ to a specified thickness.

### (3)-1 Negative Withstand-Voltage per Unit Thickness

A negative withstand-voltage per unit thickness in the highly resistive layer 13e is preferably in the range of −450V/μm to −200V/μm. The reason for this is that a balance of an improvement in the withstand-voltage in the photosensitive layer and the maintenance of sensitivity can be improved by setting the negative withstand-voltage per unit thickness in the highly resistive layer 13e in such a range.

That is, if, on the one hand, the negative withstand-voltage per unit thickness in the highly resistive layer is a value below −450V/μm, the voltage resistance of the photosensitive layer may be excessively improved, thereby making it difficult to obtain a sufficient sensitivity if the thickness of the highly resistive layer is set in the specified range. If, on the other hand, the thickness of the highly resistive layer is adjusted to reduce the voltage resistance of the photosensitive layer, this thickness may be excessively reduced, thereby making it difficult to form a uniform highly resistive layer and, conversely, excessively reducing the voltage resistance of the photosensitive layer.

Meanwhile, if the negative withstand-voltage per unit thickness in the highly resistive layer is a value above −200V/μm, the thickness of the highly resistive layer is excessively increased upon setting the voltage resistance of the photosensitive layer in a desired range. As a result, the thickness of the entire photosensitive layer may be excessively increased, thereby making it difficult to obtain a sufficient sensitivity.

It should be noted that a method for measuring the negative withstand-voltage per unit thickness in the highly resistive layer is described in Examples to be described later.

### (3)-2 Constituent Material

The highly resistive layer 13e is preferably made of amorphous silicon containing nitrogen atoms. The reason for this is that it becomes not only easy to adjust the negative withstand-voltage per unit thickness in the highly resistive layer in the specified range, but also possible to efficiently improve the adhesion of the highly resistive layer 13e to the base 13c and the charge-injection inhibition layer 13d by using the amorphous silicon containing nitrogen atoms as the constituent material of the highly resistive layer.

Further, if X (mol) denotes the content of nitrogen atoms and Y (mol) denotes the content of silicon atoms, the value of the following equation preferably lies in the range of 15% to 50%:

(X/(X+Y))×100(%).

The reason for this is that a balance of an improvement in the voltage resistance in the photosensitive layer and the maintenance of the sensitivity can be improved by setting the content ratio of nitrogen atoms and silicon atoms as above.

Namely, if (X/(X+Y))×100 is a value below 15%, it would be difficult to give a sufficient voltage resistance to the highly resistive layer and consequently the voltage resistance of the photosensitive layer may be excessively reduced. On the contrary, if (X/(X+Y))×100 is a value above 50%, an excessive voltage resistance may be given to the highly resistive layer and consequently the sensitivity of the photosensitive layer may be excessively reduced.

### (3)-3 Thickness

The thickness of the highly resistive layer 13e is in the range of 1 μm to 4 μm. The reason for this is that it is possible to obtain a specified voltage resistance while thinning the photosensitive layer with the specified structure by setting the thickness of the highly resistive layer in such a range and setting the absolute value of the solid light potential of the photosensitive layer in the specified range as described later. The more the voltage resistance improves, the more it would generally be difficult to maintain the sensitivity. However, by the effects of the specified highly resistive layer, the sensitivity can stably be maintained.

Accordingly, mutually contradicting effects of improving the resolution by thinning the photosensitive layer and suppressing the dielectric breakdown can be both realized by improving both the voltage resistance and the sensitivity.

Specifically, under the condition of setting the absolute value of the solid light potential of the photosensitive layer in the range of 20V to 100V, the withstand-voltage in the photosensitive layer may be excessively reduced, thereby making it difficult to suppress the dielectric breakdown of the photosensitive layer if the thickness of the highly resistive layer in such an amorphous silicon photoconductor is below 1 μm. Alternatively, the thickness may be excessively reduced; thereby making it difficult to form a uniform highly resistive layer, and conversely the withstand-voltage of the photosensitive layer may be reduced. On the other hand, if the thickness of the highly resistive layer in such an amorphous silicon photoconductor exceeds 4 μm, the thickness of the photosensitive layer may be excessively increased, thereby making it difficult to improve the resolution. From these perspectives, the thickness of the highly resistive layer is more preferably in the range of 2 μm to 3 μm.

In order to obtain a specified highly resistive layer, it is, of course, not only necessary to set the thickness of the highly resistive layer in the specified range, but also necessary to specify characteristics such as the negative withstand-voltage per unit thickness.

On this point, the characteristics of the highly resistive layer other than the thickness are also indirectly specified by specifying the absolute value of the solid light potential of the photosensitive layer as described in detail in the following paragraphs. Thus, concerning the highly resistive layer, desired effects can be obtained by specifying only the thickness thereof.

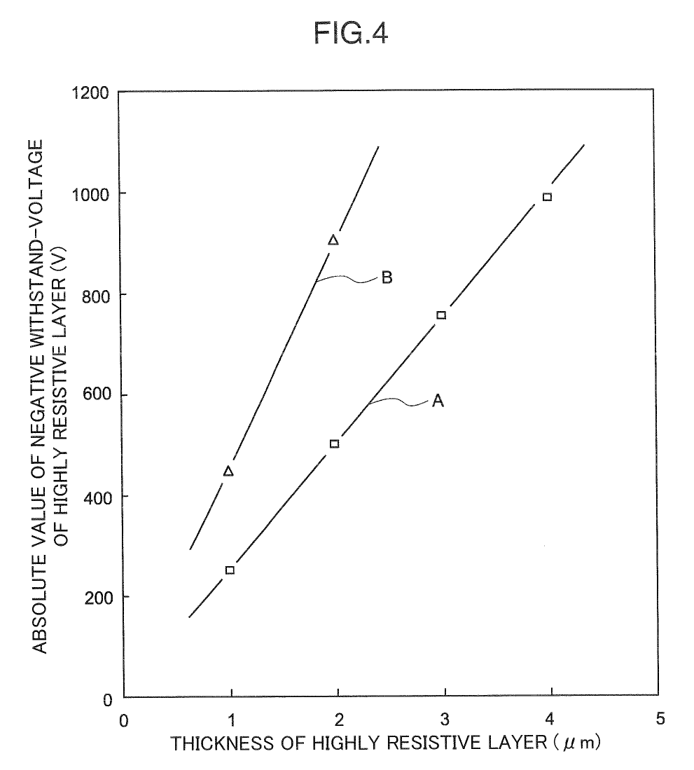

Referring now to FIG. 4, a relationship between the thickness of the highly resistive layer and the negative withstand-voltage of the highly resistive layer is described. FIG. 4 shows characteristic curves A and B with a horizontal axis representing the thickness (μm) of the highly resistive layer and a vertical axis representing the absolute value (V) of the negative withstand-voltage of the highly resistive layer.

Here, the characteristic curve A is a characteristic curve in the case of forming a highly resistive layer having a negative withstand-voltage per unit thickness of −250V/μm ((X/(X+Y))×100=30%), and the characteristic curve B is a characteristic curve in the case of forming a highly resistive layer having a negative withstand-voltage per unit thickness of −450V/μm ((X/(X+Y) )×100=50%). The method for measuring the negative withstand-voltage per unit thickness in the highly resistive layer is described in the Examples.

From the characteristic curves A and B, it is understood that the absolute values of the negative withstand-voltages of the respective highly resistive layers are proportional to the values of the thicknesses of the highly resistive layers. Accordingly, it is understood that the voltage resistance of the highly resistive layer or the photosensitive layer including the highly resistive layer can be improved and the dielectric breakdown of the photosensitive layer can be suppressed by respectively setting the absolute value of the negative withstand-voltage per unit thickness in the highly resistive layer and the thickness of the highly resistive layer to or above specified values.

On the other hand, in the case of excessively increasing the voltage resistance of the highly resistive layer, the transfer of electric charges in the photosensitive layer is suppressed, wherefore a problem of excessively reducing the sensitivity is found.

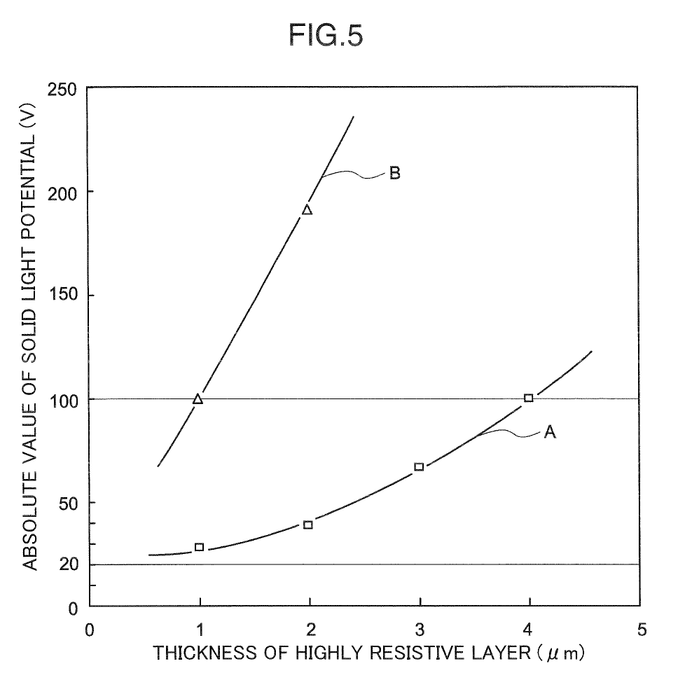

On this point, in this embodiment, both the voltage resistance and the sensitivity of the photosensitive layer can be improved by respectively specifying the thickness of the highly resistive layer and the absolute value of the solid light potential of the photosensitive layer as described next with reference to FIG. 5.

FIG. 5 shows characteristic curves A and B with a horizontal axis representing the thickness (μm) of the highly resistive layer and a vertical axis representing the absolute value (V) of the solid light potential of the photosensitive layer.

Here, the characteristic curve A is a characteristic curve in the case of forming a highly resistive layer having a negative withstand-voltage per unit thickness of −250V/μm ((X/(X+Y))×100=30%), and the characteristic curve B is a characteristic curve in the case of forming a highly resistive layer having a negative withstand-voltage per unit thickness of −450V/μm ((X/(X+Y))×100=50%).

The structure of the amorphous silicon photoconductor 13 other than the highly resistive layer 13e is as listed below.
Base 13c: aluminum tube
Charge-Injection Inhibition Layer 13d: a-SiB, thickness of 7 μm
Photoconductive Layer 13b: a-Si, thickness of 12 μm
Surface Protecting Layer 13a: a-SiC, thickness of 1 μm

The method for measuring the absolute value of the solid light potential is described in the Examples.

First of all, in the characteristic curve A, the absolute value of the solid light potential moderately increases as the thickness of the highly resistive layer increases. If the thickness of the highly resistive layer is in the range of 1 μm to 4 μm, the absolute value of the solid light potential is in the range of 20 to 100V.

Accordingly, in the case where the negative withstand-voltage per unit thickness in the highly resistive layer is −250 V/μm ((X/(X+Y))×100=30%), the absolute value of the solid light potential can be stably kept in the range of 20 to 100 V if the thickness of the highly resistive layer is in the range of 1 μm to 4 μm.

It was separately confirmed that, even if the negative withstand-voltage per unit thickness in the highly resistive layer was equal to or above −250V/μm, the absolute value of the solid light potential could be in the range of 20V to 100V by increasing the thickness of the highly resistive layer in the range up to 4 μm if this negative withstand-voltage is equal to or below −200V/μm.

On the other hand, in the characteristic curve B, the absolute value of the solid light potential suddenly increases as the thickness of the highly resistive layer increases and the absolute value of the solid light potential is equal to or above 100V if the thickness of the highly resistive layer is in the range equal to or above 1 μm.

Accordingly, in the case where the negative withstand-voltage per unit thickness in the highly resistive layer is −450 V/μm ((X/(X+Y))×100=50%), it is understood that it becomes difficult to keep the absolute value of the solid light potential in the range equal to or below 100V unless the thickness of the highly resistive layer is set in the range equal to or below 1 μm.

From the above, it is understood that the lower and upper limit values of the negative withstand-voltage per unit thickness in the highly resistive layer as the characteristics of the highly resistive layer other than the thickness can be indirectly specified by specifying the thickness of the highly resistive layer and the absolute value of the solid light potential in the photosensitive layer.

Further, the amorphous silicon photoconductor in this embodiment can easily be specified by a simple measurement method by specifying the upper and lower limit values of the negative withstand-voltage per unit thickness in the highly resistive layer by the thickness of the highly resistive layer and the absolute value of the solid light potential in the photosensitive layer, which are easy to measure, in this way.

### (3)-4 Forming Method

The highly resistive layer in the case of using the amorphous silicon containing nitrogen atoms can be formed by a physical vapor deposition method such as a sputtering method, an ion implantation method, an ion plating method or an electron beam method or a chemical vapor deposition method such as a plasma CVD method, a photo-CVD method or a catalytic CVD method.

For example, in the case of employing a sputtering method, sputtering can be performed in various gas atmospheres using a single crystal or polycrystalline Si wafer, Si₃N₄ wafer or Si wafer mixed with Si₃N₄ as a target. In other words, sputtering gas such as He, Ne or Ar is introduced into a sputter deposition chamber to form a gas plasma, whereby the above wafer can be sputtered.

Upon forming the highly resistive layer, the temperature of the base where this highly resistive layer is to be formed is preferably in the range of 20 to 200° C., more preferably in the range of 20 to 150° C.

Further, in the case of employing a sputtering method or an electron beam method, discharge power is preferably in the range of 50 W to 250 W, more preferably in the range of 80 W to 150 W.

### (4) Charge-Injection Inhibition Layer

The charge-injection inhibition layer 13d is a layer formed for the purpose of suppressing the injection of electric charges from the base 13c into the photoconductive layer 13b, particularly improving a charging characteristic when the photosensitive layer 13′ is charged.

A material obtained by containing boron atoms, gallium atoms or aluminum atoms or the like as dopants in an amorphous silicon can be used for such a charge-injection inhibition layer. Above all, the charge-injection inhibition layer is particularly preferably made of amorphous silicon containing boron atoms as dopants.

The reason for this is that the injection of electric charges from the base into the photoconductive layer can be more effectively suppressed particularly in the case of using the amorphous silicon photoconductor in a positively charged state by using the amorphous silicon containing boron atoms as dopants.

The content of boron atoms is preferably set such that a value of (X′/(X′+Y′))×100(%) is in the range of 0.01% to 1.0% when X′ (mol) denotes the content of boron atoms and Y′ (mol) denotes the content of silicon atoms and more preferably set such that this value is in the range of 0.1% to 0.5%.

The thickness of the charge-injection inhibition layer is preferably in the range of 2 μm to 10 μm. The reason for this is that the injection of electric charges from the base into the photoconductive layer can be more effectively suppressed while the photosensitive layer is thinned by setting the thickness of the charge-injection inhibition layer in such a range.

Specifically, if the thickness of the charge-injection inhibition layer is below 2 μm, it may become difficult to sufficiently inhibit the injection of electric charges from the base, thereby making it difficult to give a specified charging characteristic to the photosensitive layer. On the other hand, if the thickness of the charge-injection inhibition layer exceeds 10 μm, the thickness of the entire photosensitive layer may be excessively increased, thereby making it difficult to obtain a specified high resolution.

Accordingly, the thickness of the charge-injection inhibition layer is more preferably in the range of 3 μm to 7 μm and even more preferably in the range of 3 μm to 5 μm.

The charge-injection inhibition layer can also be formed by physical vapor deposition or chemical vapor deposition as in the case of forming the highly resistive layer.

### (5) Photoconductive Layer

The photoconductive layer 13b is a layer having functions of generating electric charges in accordance with exposure light to be incident on the photosensitive layer 13′ and transporting the generated electric charges to form an electrostatic latent image on the surface of the photosensitive layer 13′.

Amorphous silicon or amorphous silicon material obtained by containing group IIIa or Va atoms in an amorphous silicon can be used as a material for such a photoconductive layer.

The thickness of the photoconductive layer is preferably in the range of 10 μm to 21 μm. The reason for this is that a specified electric charge generating amount can be maintained to obtain a better sensitivity while the photoconductive layer is thinned by setting the thickness of the photoconductive layer in such a range, wherefore an image with a higher resolution can be formed.

Specifically, if the thickness of the photoconductive layer is below 10 μm, a part of the exposure light may pass through the photoconductive layer to be reflected by an interface with the base or the charge-injection inhibition layer, thereby causing interference. On the other hand, if the thickness of the photoconductive layer exceeds 21 μm, the thickness of the entire photosensitive layer may be excessively increased, thereby making it difficult to obtain a specified high resolution.

Accordingly, the thickness of the photoconductive layer is more preferably in the range of 10 μm to 19 μm and even more preferably in the range of 12 μm to 17 μm.

The photoconductive layer can also be formed by physical vapor deposition or chemical vapor deposition as in the case of forming the highly resistive layer.

### (6) Surface Protecting Layer

The surface protecting layer 13a is a layer formed for the purpose of giving a sufficient member resistance to the surface of the photosensitive layer 13′.

Such a surface protecting layer is preferably made of amorphous silicon containing carbon atoms. The reason for this is that the exposure light is transmitted to the photoconductive layer without being excessively absorbed while the member resistance is effectively given to the surface of the photosensitive layer and an electrostatic latent image formed by the exposure light can stably be maintained because of a specified resistance value by making the surface protecting layer of the amorphous silicon containing carbon atoms.

The content of carbon atoms is preferably set such that a value of (X″/(X″+Y″))×100(%) is in the range of 60% to 98% when X″ (mol) denotes the content of carbon atoms and Y″ (mol) denotes the content of silicon atoms and more preferably set such that this value is in the range of 80% to 95%.

The thickness of the surface protecting layer is preferably in the range of 0.4 μm to 2 μm. The reason for this is that the member resistance can be more effectively given to the photosensitive layer surface while the photosensitive layer is thinned by setting the thickness of the surface protecting layer in such a range.

Specifically, if the thickness of the surface protecting layer is below 0.4 μm, it may become difficult to give a sufficient member resistance to the photosensitive layer surface and a life against abrasion may become excessively short. On the other hand, if the thickness of the surface protecting layer exceeds 2 μm, the exposure light may be easily excessively absorbed, thereby reducing the electric charge generating amount in the photoconductive layer and the thickness of the entire photosensitive layer may be excessively increased, thereby making it difficult to obtain a specified high resolution.

Accordingly, the thickness of the surface protecting layer is more preferably in the range of 0.4 μm to 1.5 μm and even more preferably in the range of 0.6 μm to 1.2 μm.

The surface protecting layer can also be formed by physical vapor deposition or chemical vapor deposition, in such the case of forming the highly resistive layer.

### (7) Photosensitive Layer Characteristics

In this embodiment, the thickness of the photosensitive layer 13′ formed by successively laminating the highly resistive layer 13e, the charge-injection inhibition layer 13d, the photoconductive layer 13b and the surface protecting layer 13a is in the range of 15 μm to 25 μm. The reason for this is that an amorphous silicon photoconductor with good charging characteristic, electric charge generation and member resistance can be obtained since the functions of the charge-injection inhibition layer, the photoconductive layer and the surface protecting layer are exhibited by successively laminating the respective layers.

However, the photosensitive layer with such a specific structure tends to be more susceptible to dielectric breakdown due to a reduction in voltage resistance in the case of trying to improve the resolution of a formed image by thinning the thickness of the photosensitive layer to a value equal to or below 25 μm to increase capacitance.

On this point, a specified voltage resistance in this embodiment can be obtained while the photosensitive layer with the specific structure is thinned since the specified highly resistive layer is included as already described above. In the case of improving the voltage resistance, it is generally difficult to maintain the sensitivity. However, such a problem can be also solved by the effects of the specified highly resistive layer.

Meanwhile, if the thickness of the photosensitive layer with the specific structure is below 15 μm, the dielectric breakdown may easily occur and further mechanical strength may become insufficient regardless of the effects of the specified highly resistive layer.

Accordingly, the thickness of the photosensitive layer with the specific structure is more preferably in the range of 15 μm to 23 μm and even more preferably in the range of 18 μm to 21 μm.

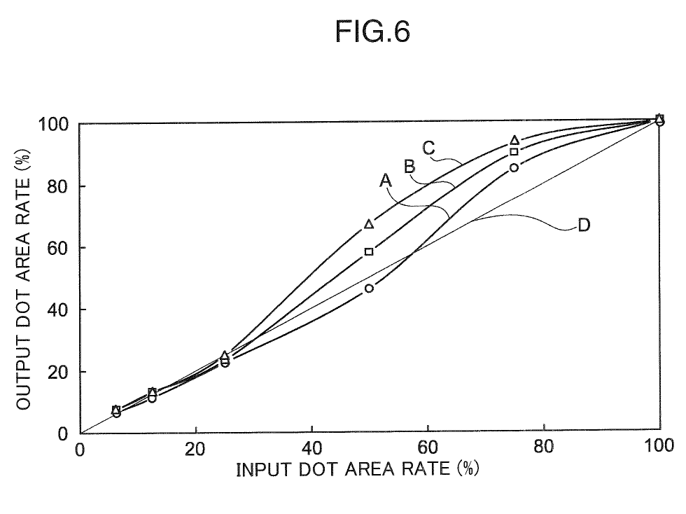

Referring now to FIG. 6, a relationship between the thickness of the photosensitive layer with the specific structure and the resolution is described. FIG. 6 shows characteristic curves A to D with a horizontal axis representing an input dot area rate (%) and a vertical axis representing an output dot area rate (%).

Here, the characteristic curves A to C are characteristic curves in the case of image formation using amorphous silicon photoconductors in which the thicknesses of photosensitive layers with the specific structure are 20 μm, 25 μm, and 30 μm. Further, the characteristic curve D is a characteristic curve representing an ideal resolution at which the input dot area rate and the output dot area rate are equal. The thicknesses of the photosensitive layers in the amorphous silicon photoconductors were adjusted by changing the thicknesses of the charge-injection inhibition layers and the photoconductive layers.

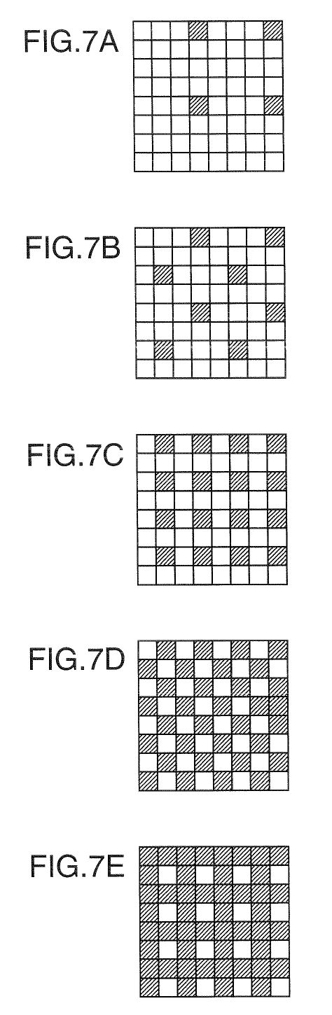

The input dot area rate is a print dot pattern as shown in FIGS. 7A to 7E. FIGS. 7A to 7E show print dot patterns whose input dot area rates are respectively, 6.25%, 12.5%, 25%, 50%, and 75%. Contrary, the output dot area rate is a value calculated by image analyzing a toner image formed on the amorphous silicon photoconductor based on the print dot pattern. In other words, the smaller a difference between the input dot area rate and the output dot area rate is, the more possible it is to form an image with a high resolution.

Thus, if the characteristic curves A to C and the characteristic curve D representing the ideal resolution at which the input dot area rate and the output dot area rate are equal are compared, it is understood that the characteristic curve A most approximates to the characteristic curve D, the characteristic curve B second most approximates to the characteristic curve D and the characteristic curve C most deviates from the characteristic curve D. From these results, it is generally understood that the resolution increases as the photosensitive layer with the specific structure becomes thinner while decreasing as the photosensitive layer with the specific structure becomes thicker.

In this embodiment, the negative withstand-voltage per unit thickness in the highly resistive layer is specified in the specific range by setting the absolute value of the solid light potential of the photosensitive layer with the specific structure in the range of 20V to 100V.

Since these discussions are already described in detail in the section of the highly resistive layer, it is not repeatedly described. In order to further improve the balance of an improvement in the voltage resistance in the photosensitive layer and the maintenance of the sensitivity, the absolute value of the solid light potential of the photosensitive layer is more preferably in the range of 20 to 90 V and even more preferably in the range of 30V to 80V.

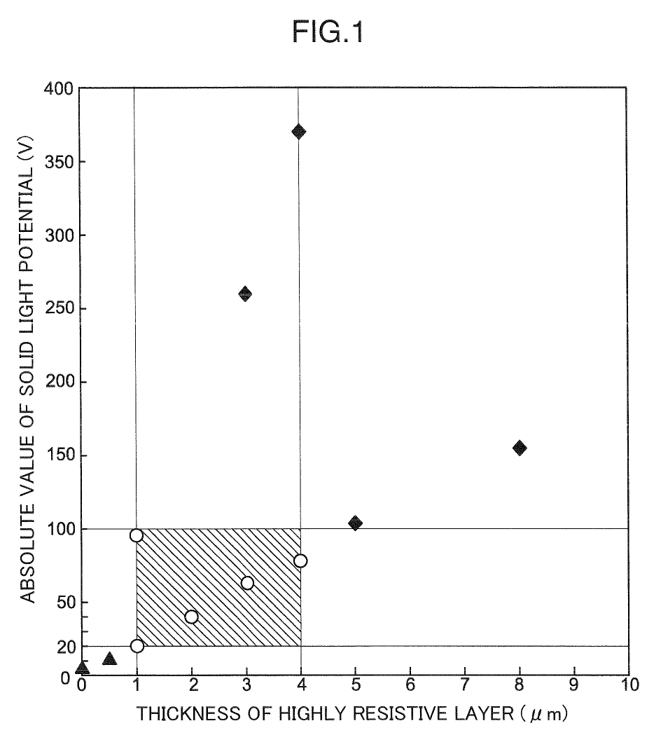

Next, with reference to FIG. 1, a relationship of the thickness of the highly resistive layer, the absolute value of the solid light potential of the photosensitive layer, the withstand-voltage and the image density is described in the case of thinning the photosensitive layer with the specific structure to a value in the range of 15 μm to 25 μm. In FIG. 1 is shown a scatter diagram with a horizontal axis representing the thickness (μm) of the highly resistive layer and a vertical axis representing the absolute value (V) of the solid light potential of the photosensitive layer.

Here, markers in the scatter diagram indicate the following contents.
◯: The absolute value of the negative withstand-voltage is equal to or above 800V, the value of the positive withstand-voltage is equal to or above 1500V and the image density is equal to or above 1.4 (−).
♦: The absolute value of the negative withstand-voltage is equal to or above 800V and the value of the positive withstand-voltage is equal to or above 1500V, but the image density is below 1.4 (−).
▴: The absolute value of the negative withstand-voltage is equal to or above 800V or the value of the positive withstand-voltage is equal to or above 1500V and the image density is equal to or above 1.4 (−).

As is understood from such a scatter diagram, even in the case of thinning the photosensitive layer with the specific structure to improve the resolution, the amorphous silicon photoconductor having good voltage resistance and sensitivity can be obtained by setting the thickness of the highly resistive layer in the range of 1 μm to 4 μm and setting the absolute value of the solid light potential in the range of 20V to 100V.

### 3. Charging Devices

The charging devices 14M to 14BK shown in FIG. 2 are devices including discharge wires and arranged above the amorphous silicon photoconductors 13M to 13BK to uniformly charge the amorphous silicon photoconductors 13M to 13BK. Non-contact charging devices such as scorotrons or corotrons including discharge wires can be used as the charging devices 14M to 14BK.

### 4. Exposing Devices

The exposing devices 15M to 15BK shown in FIG. 2 are devices for forming electrostatic latent images on the amorphous silicon photoconductors 13M to 13BK based on a document image read from an unillustrated image data input unit.

### 5. Developing Devices

The developing devices 11M to 11BK shown in FIG. 2 are devices for forming toner images by supplying toners to the surfaces of the amorphous silicon photoconductors 13M to 13BK on which the electrostatic latent images are formed. It should be noted that the developing devices are not limited to the tandem type.

### 6. Transferring Devices

The transferring devices 16M to 16BK shown in FIG. 2 are devices for transferring the toner images on the amorphous silicon photoconductors 13M to 13BK to a sheet. The transferring devices include an endless belt 15 and transfer rollers.

### 7. Cleaning Blades

The cleaning blades 22M to 22BK shown in FIG. 2 are devices for cleaning extraneous matters such as residual toners remaining on the amorphous silicon photoconductors 13M to 13BK. Blades made of a rubber having a hardness of 60 to 80 (e.g. urethane rubber) are preferably held in pressing contact with the amorphous silicon photoconductors at a line pressure of 10 to 40 N/m as the cleaning blades 22M to 22BK.

### 8. Rotary Members

The rotary members 21M to 21BK shown in FIG. 2 have a buffer function of collecting and discharging the toners by coming into contact with the surfaces of the amorphous silicon photoconductors 13M to 13BK. Here, each of the rotary members 21M to 21BK is constructed such that the outer circumferential surface of a metal shaft is covered by a rubber layer (e.g. foamed rubber layer) having a hardness of 40 to 70. The rotary members 21M to 21BK are preferably biased against the amorphous silicon photoconductors 13M to 13BK at 500 gf to 2000 gf (250 gf to 1000 gf per spring) by springs (not shown) disposed at the opposite ends of bearings.

### 9. Fixing Device

The fixing device 20 shown in FIG. 2 is a device for fixing transferred toner images to a sheet. The fixing device 20 thermally fuses the toners transferred to a transfer member such as a paper sheet by means of a heat roller.

### 10. Neutralizing Devices

The neutralizing devices 24M to 24BK shown in FIG. 2 are arranged further downstream of the transferring devices 16M to 16BK along the rotating directions of the amorphous silicon photoconductors 13M to 13BK. Such neutralizing devices 24M to 24BK preferably include LEDs (light emitting diodes) and reflectors.

It is also preferable to uses EL (electroluminescence) light sources, fluorescent lights or the like in place of the LEDs.

### Second Embodiment

A second embodiment concerns an image forming method using the image forming apparatus described in the first embodiment. The image forming method as the second embodiment is described below, taking a full-color image forming method using the full-color image forming apparatus as an example, with the description centered on points of difference from the first embodiment.

First of all, after the amorphous silicon photoconductors 13M to 13BK of the image forming apparatus 10 shown in FIG. 2 are rotated at a specified process speed (circumferential speed) in clockwise directions shown by arrows in FIG. 2, the surfaces thereof are charged to a specified potential by the charging devices 14M to 14BK.

Subsequently, the surfaces of the amorphous silicon photoconductors 13M to 13BK are exposed with exposure lights emitted from the exposing devices 15M to 15BK and transmitted via reflecting mirrors or the like while being modulated in accordance with image information. By these exposure lights, electrostatic latent images of the respective colors are formed on the surfaces of the amorphous silicon photoconductors 13M to 13BK.

Subsequently, these electrostatic latent images are developed by the developing devices 11M to 11BK. Developers of the respective colors (magenta, cyan, yellow, and black) are contained in these developing devices 11M to 11BK and attached to the corresponding electrostatic latent images on the surfaces of the amorphous silicon photoconductors 13M to 13BK to form developer images.

A recording sheet is conveyed along a specified transfer/conveyance path to positions below the amorphous silicon photoconductors 13M to 13BK. At this time, the developer images can be transferred to the recording sheet by applying specified transfer biases between the amorphous silicon photoconductors 13M to 13BK and the transferring devices 16M to 16BK.

Subsequently, the recording sheet after the transfer of the developer images is separated from the surfaces of the amorphous silicon photoconductors 13M to 13BK by a separating device (not shown) and conveyed to the fixing device 20 by the conveyor belt 15. Then, after the developer images are fixed to the surface of the recording sheet by heating and pressing by this fixing device 20, the recording sheet is discharged to the outside of the image forming apparatus 10 by discharge rollers.

On the other hand, the amorphous silicon photoconductors 13M to 13BK after the transfer of the developer images continue to rotate and untransferred developers remaining on the surfaces of the amorphous silicon photoconductors 13M to 13BK are scraped off by the cleaning blades 22M to 22BK provided in the cleaning devices 23M to 23BK.

Residual electric charges in the photosensitive layers of the amorphous silicon photoconductors 13M to 13BK are removed by neutralizing lights irradiated from the neutralizing devices 24M to 24BK.

According to the image forming method of this embodiment, an image with a pretty fine resolution can stably be formed since the image forming apparatus including the specified amorphous silicon photoconductors described in detail in the first embodiment is used.

### EXAMPLES

Hereinafter, the present invention is described in more detail by way of examples. It goes without saying that the following description is for illustrating the present invention and the scope of the present invention is not limited to the following description without any particular reason.

### Example 1

### 1. Manufacturing of the Amorphous Silicon Photoconductor

In a glow discharge resolving apparatus, amorphous silicon photoconductors were manufactured under conditions shown in TABLE-1 using a RF power of 13.56 MHz.

TABLE 1

| | | LAYER TYPE | | | | |
|---|---|---|---|---|---|---|
| | | | | | SURFACE PROTECTING | |
| | | H-RESISTIVE | CHARGE-INJECTION | PHOTOCONDUCTIVE | LAYER | |
| | | LAYER | INHIBITION LAYER | LAYER | 1^{ST} LAYER | 2^{ND} LAYER |
| GAS | SiH₄ | 113 | 130 | 300 | 30 | 0.6 |
| FLOW | B₂H₆* | — | 0.16% | 0.7 ppm | — | — |
| RATE | NO* | 10% | 10% | — | — | — |
| | CH₄ | — | — | — | 30 | 600 |
| | H₂ | 250 | 100 | 300 | 60 | 35 |
| | NH₃ | 160 | — | — | — | — |

| | | | | | |
|---|---|---|---|---|---|
| GAS PRESSURE | 60 | 60 | 60 | 80 | 80 |
| (Pa) | | | | | |
| BASE PLATE | 290 | 270 | 270 | 300 | 300 |
| TEMP (° C.) | | | | | |
| PP POWER (W) | 133 | 135 | 300 | 150 | 150 |

| | | | | |
|---|---|---|---|---|
| THICKNESS | 1 | 4 | 12 | 1 (1^{ST} LAYER + 2^{ND} |
| (μm) | | | | LAYER) |

*in TABLE-1 designates a flow rate ratio to SiH₄ gas.

### 2. Measurement of the Solid Light Potential

The amorphous silicon photoconductors manufactured as above were installed in the image forming apparatus 10 shown in FIG. 2 and the solid light potentials were measured.

Specifically, the developing devices were removed, potential probes were set at developing positions, and surface potentials at the developing positions in the case of forming solid images were measured. Image forming conditions were as follows.
Surface potential: 300 V
Light quantity on the amorphous silicon photoconductors: 0.9 μJ/cM²
Photoconductor rotating speed: 150 mm/sec
Resolution: 600 dpi

### 3. Evaluation

### (1) Evaluation on the Withstand-Voltage of the Photosensitive Layer

The withstand-voltages of the photosensitive layers were measured by a needle contact type pressure-withstand method. Specifically, the tip of a needle electrode having a diameter φ of 0.5 mm was brought into contact with the surface protecting layer of the amorphous silicon photoconductor, a voltage was applied at intervals of 1V and a voltage immediately before a current flowed was set as a withstand-voltage.

Both positive withstand-voltages measured by the application of a positive voltage and negative withstand-voltages measured by the application of a negative voltage were measured.

The obtained measurement result was evaluated based on the following criteria. The obtained evaluation result is shown in TABLE-2.
◯: The absolute value of the negative withstand-voltage is equal to or above 800V and the value of the positive withstand-voltage is equal to or above 1500V.
×: The absolute value of the negative withstand-voltage is below 800V or the value of the positive withstand-voltage is below 1500V.

A negative withstand-voltage per unit thickness in the highly resistive layer was calculated from the above measurement values of the negative withstand-voltages of the photosensitive layers. In other words, a plurality of amorphous silicon photoconductors differing only in the thickness of the highly resistive layer were manufactured and the negative withstand-voltage per unit thickness in the highly resistive layer was calculated from a difference in the negative withstand-voltages of the photosensitive layers and a difference in the thicknesses of the highly resistive layers in the respective amorphous silicon photoconductors. The obtained result is shown in TABLE-2.

### (2) Evaluation on Resolution

The manufactured amorphous silicon photoconductors were installed in the image forming apparatus 10 shown in FIG. 2 and ratios (dot area rate ratios) of output dot area rates to input dot area rates were obtained.

Specifically, areas of toner images on the photoconductors were measured at the time of printing print patterns of 50%, and the ratios (dot area rate ratios) of the output dot area rates to the input dot area rates were obtained by image analysis.

The obtained measurement result was evaluated based on the following criteria. The obtained evaluation result is shown in TABLE-2.
◯: The dot area rate ratio is equal to or below 120.
×: The dot area rate ratio is above 120.

### (3) Evaluation on Image Density

The manufactured amorphous silicon photoconductors were installed in the image forming apparatus 10 shown in FIG. 2 and image densities were measured.

Specifically, an image evaluation pattern was printed in a normal environment (20° C., 65% RH) and solid image densities as image evaluation patterns were measured using a Macbeth reflection densitometer.

The obtained measurement result was evaluated based on the following criteria. The obtained evaluation result is shown in TABLE-2.
◯: The image density is a value≧1.4.
Δ: The image density is a value≧1.2 and below 1.4.
×: The image density is a value below 1.2.

### Examples 2 to 5 and Comparative Examples 1 to 11

In Examples 2 to 5 and Comparative Examples 1 to 11, amorphous silicon photoconductors were respectively manufactured as in Example 1 except that a gas flow rate, a gas pressure, a base plate temperature and an RF power were suitably adjusted upon manufacturing the amorphous silicon photoconductors, and evaluated. The constructions of the respective amorphous silicon photoconductors and the obtained evaluation result are shown in TABLE-2.

TABLE 2

| | | | | | | | | | EVALUATION | | | | | |
|---|---|---|---|---|---|---|---|---|---|---|---|---|---|---|
| | H-RESISTIVE | | | | | | | | WITHSTAND- | | | | | |
| | LAYER | | | | | | PC-LAYER | | VOLTAGE | | | | RESOLUTION | |
| | A | B | C | D | E | F | G | H | I | J | K | L | M | N |
| EX. 1 | 30 | 250 | 1.0 | 4.0 | 12.0 | 1.0 | 18.0 | 20 | 1600 | 800 | ◯ | ◯ | 87 | ◯ |
| EX. 2 | | | 2.0 | | | | 19.0 | 40 | 1800 | 1100 | ◯ | ◯ | 91 | ◯ |
| EX. 3 | | | 3.0 | | | | 20.0 | 63 | 2010 | 1490 | ◯ | ◯ | 92 | ◯ |
| EX. 4 | | | 4.0 | | | | 21.0 | 78 | 2200 | 1700 | ◯ | ◯ | 94 | ◯ |
| EX. 5 | 50 | 450 | 1.0 | | | | 18.0 | 95 | 1800 | 1000 | ◯ | ◯ | 89 | ◯ |
| CEX. 1 | 30 | 250 | 0.0 | 7.0 | 20.0 | | 28.0 | 5 | 2400 | 1000 | ◯ | ◯ | 125 | X |
| CEX. 2 | | | 1.0 | | | | 29.0 | 22 | 2600 | 1300 | ◯ | ◯ | 131 | X |
| CEX. 3 | | | 4.0 | | | | 32.0 | 82 | 3200 | 2200 | ◯ | ◯ | 136 | X |
| CEX. 4 | | | 0.0 | 4.0 | 12.0 | | 17.0 | 5 | 1400 | 600 | X | ◯ | — | — |
| CEX. 5 | | | 0.5 | | | | 17.5 | 11 | 1480 | 620 | X | ◯ | — | — |
| CEX. 6 | | | 5.0 | | | | 22.0 | 104 | 2450 | 2010 | ◯ | Δ | — | — |
| CEX. 7 | | | 8.0 | | | | 25.0 | 155 | 3000 | 3000 | ◯ | X | — | — |
| CEX. 8 | 50 | 450 | 1.0 | 7.0 | 20.0 | | 29.0 | 101 | 2800 | 1400 | ◯ | Δ | — | — |
| CEX. 9 | | | 4.0 | | | | 32.0 | 380 | 3700 | 2800 | ◯ | X | — | — |
| CEX. 10 | | | 3.0 | 4.0 | 12.0 | | 20.0 | 260 | 2400 | 1850 | ◯ | X | — | — |
| CEX. 11 | | | 4.0 | | | | 21.0 | 370 | 2700 | 2300 | ◯ | X | — | — |

A: N CONTENT (%),
B: NEGATIVE WITHSTAND-VOLTAGE PER UNIT THICKNESS (ABSOLUTE VALUE) (V/μm),
C: THICKNESS
D: CHARGE-INJECTION INHIBITION LAYER THICKNESS (μm),
E: PHOTOCONDUCTIVE LAYER THICKNESS (μm),
F: SURFACE PROTECTING LAYER THICKNESS (μm),
G: THICKNESS (μm),
H: SOLID LIGHT POTENTIAL (V),
I: WITHSTAND-VOLTAGE (POSITIVE) (V),
J: WITHSTAND-VOLTAGE (NEGATIVE) (ABSOLUTE VALUE) (V),
K: QUALITY CONFORMANCE,
L: IMAGE DENSITY,
M: DOT AREA RATE RATIO (%),
N: QUALITY CONFORMANCE

According to the amorphous silicon photoconductor and the image forming apparatus according to the present invention, a specified voltage resistance can be obtained while the sensitivity can stably be maintained even in the case of thinning the photosensitive layer with the specific structure by forming the highly resistive layer of the specified thickness and the like on the base and by setting the absolute value of the solid light potential of the photosensitive layer in the specified range.

As a result, even in the case of thinning the photosensitive layer with the specific structure, an image with a pretty fine resolution can stably be formed by suppressing an occurrence of a dielectric breakdown.

Thus, the amorphous silicon photoconductor and the image forming apparatus according to the present invention are expected to remarkably contribute to improving image characteristics of various image forming apparatuses such as copiers and printers and extending the lives of these apparatuses.

The above specific embodiments mainly embrace inventions having the following constructions.

An image forming apparatus according to one aspect of the present invention comprises an image forming unit provided with an amorphous silicon photoconductor. The amorphous silicon photoconductor includes a base and a photosensitive layer provided on the base, the photosensitive layer including: a highly resistive layer, a charge-injection inhibition layer, a photoconductive layer and a surface protecting layer successively laminated on the base, wherein the thickness of the highly resistive layer is in the range of 1 μm to 4 μm, the thickness of the photosensitive layer is in the range of 15 μm to 25 μm and the absolute value of a solid light potential of the photosensitive layer is in the range of 20V to 100V.

According to this construction, a specified voltage resistance can be obtained while the photosensitive layer with the specific structure is thinned by setting the thickness of the highly resistive layer formed on the base in the specified range and setting the absolute value of the solid light potential of the photosensitive layer in the specified range. Further, in the case of improving the voltage resistance, it generally becomes difficult to maintain sensitivity. However, if the above construction is employed, the sensitivity can stably be maintained since the specified highly resistive layer is included.

Thus, mutually contradicting effects of improving the resolution by thinning the photosensitive layer and suppressing the dielectric breakdown can be both realized by improving both the voltage resistance and the sensitivity.

Therefore, according to the image forming apparatus using the above amorphous silicon photoconductor, an image with a pretty fine resolution can stably be formed. The above solid light potential means a saturated light potential in the case of irradiating a charged photoconductor with a sufficient amount of exposure light.

In the above construction, a negative withstand-voltage per unit thickness in the highly resistive layer is preferably in the range of −450V/μm to −200V/μm.

By such a construction, a balance of an improvement in the voltage resistance in the photosensitive layer and the maintenance of the sensitivity can be more improved.

It is preferable that the highly resistive layer is made of amorphous silicon containing nitrogen atoms; and that a value given by the following equation is in the range of 15% to 50% when X (mol) denotes the content of nitrogen atoms and Y (mol) denotes the content of silicon atoms:

(X/(X+Y))×100(%).

By such a construction, the balance of the improvement in the voltage resistance in the photosensitive layer and the maintenance of the sensitivity can be even more improved.

In the above construction, the charge-injection inhibition layer is preferably made of amorphous silicon containing boron atoms. According to this construction, the injection of electric charges from the base into the photoconductive layer can be more effectively suppressed particularly in the case of using the positively charged amorphous silicon photoconductor.

In the above construction, the surface protecting layer is preferably made of amorphous silicon containing carbon atoms.

By such a construction, the exposure light can be transmitted to the photoconductive layer without being excessively absorbed while member resistance is effectively given to the photosensitive layer surface, and an electrostatic latent image formed by the exposure light can stably be maintained because of a specified resistance value.

In the above construction, the thickness of the charge-injection inhibition layer is preferably in the range of 2 μm to 10 μm. By such a construction, the injection of electric charges from the base into the photoconductive layer can be more effectively suppressed while the photosensitive layer is thinned.

In the above construction, the thickness of the photoconductive layer is preferably in the range of 10 μm to 21 μm. By such a construction, a specified electric charge generating amount can be maintained and a better sensitivity can be obtained while the photosensitive layer is thinned, wherefore an image with a better resolution can be formed.

In the above construction, the thickness of the surface protecting layer is preferably in the range of 0.4 μm to 2 μm. By such a construction, member resistance can be more effectively given to the photosensitive layer surface while the photosensitive layer is thinned.

In the above construction, it is preferable that the highly resistive layer is made of amorphous silicon containing nitrogen atoms; a value given by the following equation is in the range of 15% to 50% when X (mol) denotes the content of nitrogen atoms and Y (mol) denotes the content of silicon atoms:

(X/(X+Y))×100(%);
that the charge-injection inhibition layer is made of amorphous silicon containing boron atoms; and that the surface protecting layer is made of amorphous silicon containing carbon atoms.

Further, it is preferable that the thickness of the charge-injection inhibition layer is in the range of 2 μm to 10 μm; that the thickness of the photoconductive layer is in the range of 10 μm to 21 μm; and that the thickness of the surface protecting layer is in the range of 0.4 μm to 2 μm.

In the above construction, the amorphous silicon photoconductor is preferably a photoconductive drum having the photosensitive layer provided on a metal tube as the base.

According to such an image forming apparatus, an image with a pretty fine resolution can stably be formed since the amorphous silicon photoconductor having the above construction is installed.

This application is based on Japanese Patent application serial No. 2008-071088 filed in Japan Patent Office on Mar. 19, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus comprising an image forming unit provided with an amorphous silicon photoconductor, the amorphous silicon photoconductor includes
a base and
a photosensitive layer provided on the base,
the photosensitive layer including: a highly resistive layer; a charge-injection inhibition layer; a photoconductive layer; and a surface protecting layer successively laminated on the base,
wherein:
the thickness of the highly resistive layer is in the range of 1 μm to 4 μm;
the thickness of the photosensitive layer is in the range of 15 μm to 25 μm; and
the absolute value of a solid light potential of the photosensitive layer is in the range of 20V to 100V.

2. An image forming apparatus according to claim 1, wherein a negative withstand-voltage per unit thickness in the highly resistive layer is in the range of −450V/μm to −200V/μm.

3. An image forming apparatus according to claim 1, wherein:
the highly resistive layer is made of amorphous silicon containing nitrogen atoms; and
a value given by the following equation is in the range of 15% to 50% when X (mol) denotes the content of nitrogen atoms and Y (mol) denotes the content of silicon atoms:
(X/(X+Y))×100(%).

4. An image forming apparatus according to claim 1, wherein the charge-injection inhibition layer is made of amorphous silicon containing boron atoms.

5. An image forming apparatus according to claim 1, wherein the surface protecting layer is made of amorphous silicon containing carbon atoms.

6. An image forming apparatus according to claim 1, wherein the thickness of the charge-injection inhibition layer is in the range of 2 μm to 10 μm.

7. An image forming apparatus according to claim 1, wherein the thickness of the photoconductive layer is in the range of 10 μm to 21 μm.

8. An image forming apparatus according to claim 1, wherein the thickness of the surface protecting layer is in the range of 0.4 μm to 2 μm.

9. An image forming apparatus according to claim 1, wherein:
the highly resistive layer is made of amorphous silicon containing nitrogen atoms;
a value given by the following equation is in the range of 15% to 50% when X (mol) denotes the content of nitrogen atoms and Y (mol) denotes the content of silicon atoms:
(X/(X+Y))×100(%);
the charge-injection inhibition layer is made of amorphous silicon containing boron atoms; and
the surface protecting layer is made of amorphous silicon containing carbon atoms.

10. An image forming apparatus according to claim 1, wherein:
the thickness of the charge-injection inhibition layer is in the range of 2 μm to 10 μm;
the thickness of the photoconductive layer is in the range of 10 μm to 21 μm; and
the thickness of the surface protecting layer is in the range of 0.4 μm to 2 μm.

11. An image forming apparatus according to claim 10, wherein the amorphous silicon photoconductor is a photoconductive drum having the photosensitive layer provided on a metal tube as the base.
